(19) United States
(12) Patent Application Publication
(10) Pub. No.: US 2008/0006967 A1
(43) Pub. Date: Jan. 10, 2008

(54) METHOD OF FABRICATING A POLYMER MATERIAL ENDOPROSTHESIS BY MOLDING

(75) Inventors: ETIENNE MALHER, Nancy (FR); Sylvain Siegel, Nancy (FR)

Correspondence Address: SUGHRUE MION, PLLC, 2100 PENNSYLVANIA AVENUE, N.W., SUITE 800, WASHINGTON, DC, 20037, US

(73) Assignee: MS TECHNIQUES, a French Corporation, Pompey (FR)

(21) Appl. No.: 11/772,360

(22) Filed: Jul. 2, 2007

(30) Foreign Application Priority Data
Jul. 4, 2006 (FR) 06 06080

(51) Int. Cl. B28B 1/28

(52) U.S. Cl. 264/310; 425/418

(57) ABSTRACT

A method of fabricating a polymer material endoprosthesis by molding, said method comprising: molding the endoprosthesis on a matrix roller having an outer surface that includes a recess in the form of the prosthesis, the matrix roller being rotated about its axis; removing excess polymer material by scraping the surface of the matrix roller; allowing the endoprosthesis to solidify; and withdrawing the endoprosthesis from the matrix roller.

The present invention relates to fabricating a polymer material endoprosthesis.

### BACKGROUND OF THE INVENTION

Endoprostheses are medical implants of generally tubular shape that serves to keep open a duct that is tending to close under the effect of a pathology, such as a tumor, atherosclerotic plaques, etc. . . . The duct that is to be kept open is constituted, for example by an artery, a vein, a respiratory tract, a urinary passage, or a bile duct.

To make them easier to put into place, endoprostheses need to be deformable between a contracted state and an expanded state. Endoprostheses are introduced into ducts while in a contracted state so as to enable them to be moved to their implantation site in a manner that is not very traumatic, and they are then expanded to their final size either by plastic deformation using appropriate tooling, or by an elastic return.

Endoprostheses are known that are made of stainless steel or of nickel titanium alloy, having the general shape of a tubular braid or of a highly perforated tube leaving only a thin network of metal arms that are organized to obtain good flexibility in the contracted position and good mechanical strength after deployment. They can be made by braiding a metal wire, by making cutouts in a metal tube having the final diameter of the implant in its expanded mold, or by making cutouts in a metal tube having the diameter of the implant in its contracted mold. They may possibly be subjected to surface treatment in order to fix molecules on their surface that have a therapeutic effect.

Those metal endoprostheses present the drawbacks firstly of being expensive to make and secondly of being suitable for use with only a limited range of surface treatments, and finally of being non-degradable, which means that they can be removed only by withdrawing them by an appropriate operation.

In order to remedy those drawbacks, proposals have been made to make endoprostheses out of polymer material, thus having the advantage of better biocompatibility than the metal materials usually used, of enabling molecules to be chemically grafted that have therapeutic effects, such as inhibitors of re-stenosis or anticoagulants, and of being less expensive to make. In addition, providing a resorbable polymer is used, it is possible to make endoprostheses that disappear after a certain length of time, thereby eliminating the risk of re-stenosis caused by a foreign body.

Nevertheless, fabricating polymer endoprostheses presents difficulties. Because of the shape of such endoprostheses, and in particular the shape of the arms that make them up and that are of very small section while being of relatively great length, it is difficult to use conventional molding techniques to obtain proper filling of molds and endoprostheses of satisfactory shape. In particular, because of the complex shape of endoprostheses, conventional injection molding leads to the presence of a very large number of re-welded zones that constitute points of weakness. Furthermore, for questions of ability to withstanding aging, it can be desirable to use polymers of high molecular weight, which present viscosities in the molten state that are large, thereby making molding that much more difficult.

### OBJECT AND SUMMARY OF THE INVENTION

The object of the present invention is to remedy those drawbacks by proposing means for fabricating polymer material endoprostheses by molding in a manner that is less expensive and more reliable, and that enables polymers to be used that are more viscous than those used in known molding methods.

To this end, the invention provides a method of fabricating a polymer material endoprosthesis by molding, the method comprising: molding the endoprosthesis on a matrix roller having an outer surface that includes a recess in the shape of the prosthesis, the matrix roller being rotated about its axis; pressing the matrix roller against a backing roller of axis parallel to the axis of the matrix roller, the backing roller being rotated in the opposite direction to the matrix roller and serving to ensure that the recess is properly filled; removing excess polymer material, by scraping the surface of the matrix roller; using a scraper having an edge parallel to the axis of the matrix roller; allowing the endoprosthesis to solidify; and then withdrawing the endoprosthesis from the matrix roller.

Preferably, while the matrix roller is being filled, at least the matrix roller is heated to a temperature lying between the melting temperature and the degradation temperature of the polymer.

Preferably after the matrix roller has been filled, at least the matrix roller is cooled in order to allow the endoprosthesis to solidify.

The material may be fed in the form of granules or powder and is caused to melt in contact with the matrix roller.

The polymer material may also be fed in the molten state.

After the matrix roller has been filled, the matrix roller may be moved away to allow the endoprosthesis to solidity and be withdrawn, and another matrix roller takes its place and is filled with polymer material.

Molding may be performed in an enclosure containing an inert atmosphere.

The invention also provides a device for fabricating a polymer material endoprosthesis by molding using the method of the invention. The device comprises a matrix roller having a surface including a recess in the form of the endoprosthesis, and a backing roller that is parallel thereto, the rollers being mounted to rotate about their respective axes and being movable relative to each other so as to be capable of being moved apart or towards each other, means for driving the rollers in rotation, and means for moving the rollers relative to each other, heater and cooler means for the rollers, scraper means for scraping the surface of the matrix roller, and polymer material feeder means.

The matrix roller, the backing roller, and the scraper means may be disposed in an enclosure containing an inert atmosphere.

### BRIEF DESCRIPTION OF THE DRAWINGS

The invention is described in greater detail but in non-limiting manner below with reference to the accompanying figures, in which:

FIG. 1 is a perspective view of an endoprosthesis of polymer material;

FIG. 2 is a diagrammatic view of an installation for molding an endoprosthesis of polymer material; and

FIG. 3 is a perspective view of a device for molding an endoprosthesis, the device comprising a cylindrical mold.

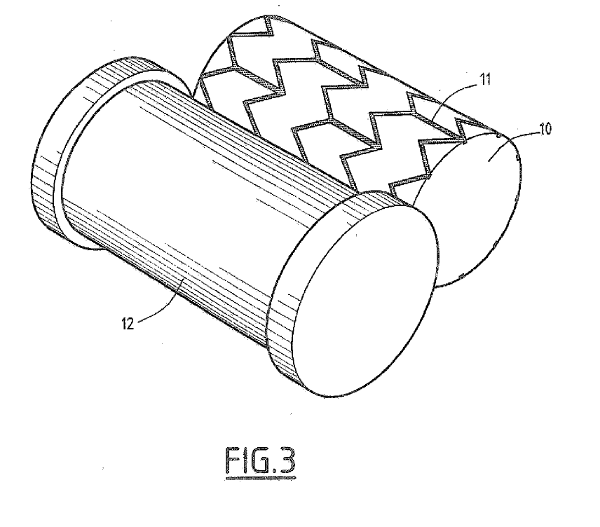

### MORE DETAILED DESCRIPTION

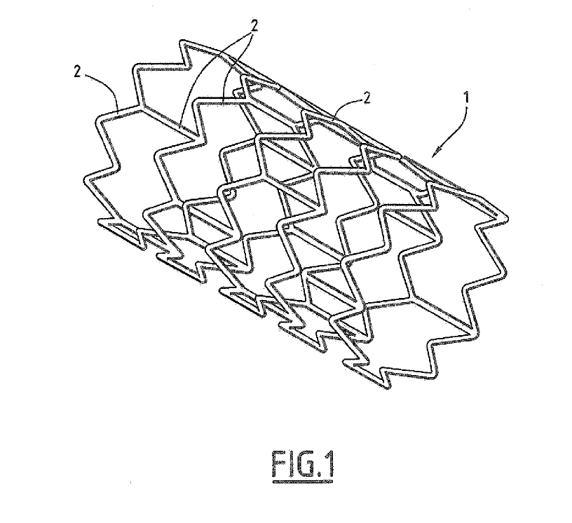

The endoprosthesis given overall reference 1 in FIG. 1 is a highly perforated tube made up of arms 2, that are of small diameter and of length that is long relative to the diameter, the arms being disposed in a network so as to form a perforated cylindrical wall.

The arms are disposed so as to form arms with angles so that the cylindrical surface is resilient and capable of being deformed between a contracted position and an expanded position. Such an endoprosthesis is known in itself and is made of a biocompatible thermoplastic polymer material, likewise known in itself.

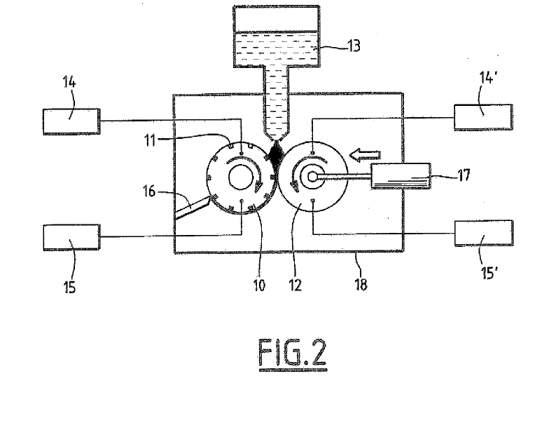

To fabricate the endoprosthesis shown in FIG. 1, a molding method is used that relies on a molding device as shown in FIG. 2 that comprises a matrix roller 10 of cylindrical shape with its outside surface including a recess 11 having the shape of an endoprosthesis, e.g. in its expanded position, and a backing roller 12 of axis parallel to the matrix roller 10, and disposed close to the matrix roller.

The matrix roller 10 and the backing roller 12 have axes that are horizontal, mutually parallel, and positioned so as to be capable of co-operating with each other via a generator line.

The molding device also has polymer material feed means 13 disposed so as to be capable of delivering polymer material into the zone of contact between the matrix roller and the backing roller.

The polymer material feed means 13 may be constituted either by a dispenser of polymer material in granule or powder form, or by a device for feeding polymer material that is already molten, such as an extruder.

The matrix roller 10 includes heater means 14 and cooler means 15.

By way of example, the heater means 14 are constituted by a device for circulating hot fluids, such as hot water, or indeed heater means using an electrical resistance.

The cooler means 15 are constituted for example by a device for circulating cold water.

The heater and cooler means 14 and 15 can be controlled so as to be capable of heating the roller 10 and then cooling it, in succession.

The backing roller 12 also has heater means 14′ and cooler means 15′ serving to heat and to cool it. These means are similar to those of the matrix roller.

In addition, the backing roller 12 is mounted on a moving support that is driven by displacement means 17, such as an actuator, enabling it to be moved horizontally and serving to adjust its distance from the matrix roller. The displacement means 17 also serves optionally to adjust the contact pressure against the matrix roller.

The matrix roller 10 and the backing roller 12 include rotary drive means (not shown) such as electric S motors, enabling the two rollers to be turned in mutually opposite directions at speeds that can be different.

The molding device further comprises scraper means 16 constituted by a blade that can be brought into contact with the surface of the matrix roller.

Finally, the assembly is contained in an enclosure 18 that can be filled with an inert gas, such as nitrogen.

There follows a description of fabricating an endoprosthesis with an installation fed with solid polymer granules or powder.

Initially, the matrix roller and the backing roller are raised to a temperature higher than the melting temperature of the polymer and lower than its degradation temperature. The two rollers are then moved towards each other but without touching.

The two cylinders are set into rotation in opposite directions in such a manner that the linear speeds at the surfaces of the cylinders are substantially equal, or slightly different depending on whether it is desired to avoid or to obtain a shear effect.

Using the feeder means 13, polymer granules or powder are spread onto the contact zone between the two cylinders in a quantity that is slightly greater than the quantity needed to fill the recess in the matrix roller. Under the effect of the temperature of the matrix roller and of the backing roller, the polymer in granule or powder form melts, spreads, and covers the surface of the matrix roller. Once the molten polymer is well spread over the entire length of the matrix roller, the rollers are moved so as to be pressed together and ensure that the recess in the matrix roller is properly filled. The scraper 16 is then moved closer so as to scrape the surface of the matrix roller and remove excess polymer material in the molten state.

The matrix roller and possibly also the backing roller is/are then cooled so as to allow the polymer material filling the recess in the matrix roller to solidify.

Once the material filling the recess in the matrix roller and thus constituting an endoprothesis has solidified, the matrix roller is moved away and the endoprosthesis is withdrawn from the matrix roller.

Throughout these operations, the enclosure can be filled with an inert gas such as nitrogen, so as to avoid chemical reactions between the polymer and the atmosphere in which molding is taking place. This inert atmosphere is particularly useful when the polymer is sensitive to oxidation or to hydrolysis.

The above-described installation may have a plurality of matrix rollers mounted on a device that enables the matrix roller to be changed, thereby enabling the matrix roller to be removed after it has been filled, so that solidification takes place away from the filling zone, and while solidification is taking place in the recess of a matrix roller that has already been filled, a new matrix roller can be placed in the filling zone. This disposition has the advantage of increasing productivity by performing filling and solidification in parallel.

In a variant of this endoprosthesis fabrication method, a feeder device 13 is used that includes heater means enabling already molten polymer to be fed to the contact zone between the matrix roller and the backing roller. Since the polymer is already molten, the duration of contact between the polymer material and the heated rollers can be reduced considerably, since there is no longer any need to melt the polymer material. This makes it possible to increase productivity significantly.

This method has the advantage of very good yield and also of using small quantities of material, which is an advantage in particular when prostheses are made of polymers that are resorbable and thus polymers that are very expensive.

The method also has the advantage of reducing the length of time the material is hot, and thus of reducing the degradation that can result from the material spending time at high temperature.

Naturally, the conditions under which the rollers are heated and their relative speeds need to be adapted as a function of the natures of the polymers and of the specific shape of the endoprosthesis that is to be made, and the person skilled in the art knows how to make the necessary adaptations.

What is claimed is:

1. A method of fabricating a polymer material endoprosthesis by molding, the method comprising: molding the endoprosthesis on a matrix roller having an outer surface that includes a recess in the shape of the prosthesis, the matrix roller being rotated about its axis, pressing the matrix roller against a backing roller of axis parallel to the axis of the matrix roller, the backing roller being rotated in the opposite direction to the matrix roller and serving to ensure that the recess is properly filled; removing excess polymer material by scraping the surface of the matrix roller; allowing the endoprosthesis to solidify; and then withdrawing the endoprosthesis from the matrix roller.

2. A method according to claim 1, wherein while the matrix roller is being filled, at least the matrix roller is heated to a temperature lying between the melting temperature and the degradation temperature of the polymer.

3. A method according to claim 2, wherein after the matrix roller has been filled, at least the matrix roller is cooled in order to allow the endoprosthesis to solidify.

4. A method according to claim 2, wherein the material is fed in the form of granules or powder and is caused to melt in contact with the matrix roller.

5. A method according to claim 1, wherein the polymer material is fed in the molten state.

6. A method according to claim 1, wherein after the matrix roller has been filled, the matrix roller is moved away to allow the endoprosthesis to solidify and be withdrawn, and another matrix roller takes its place and is tilled with polymer material.

7. A method according to claim 1, wherein molding is performed in an enclosure containing an inert atmosphere.

8. A device for fabricating a polymer material endoprosthesis by molding by using the method according to claim 1, the device having both a matrix roller having a surface including a recess in the form of the endoprosthesis, and a backing roller that is parallel thereto, the rollers being mounted to rotate about their respective axes and being movable relative to each other so as to be capable of being moved apart or towards each other, means for driving the rollers in rotation, and means for moving the rollers relative to each other, heater and cooler means for the rollers, scraper means for scraping the surface of the matrix roller, and polymer material feeder means.

9. A device according to claim 8, wherein the matrix roller, the backing roller, and the scraper means are disposed in an enclosure containing an inert atmosphere.
